(19) United States
(12) Patent Application Publication
(10) Pub. No.: US 2022/0272947 A1
(43) Pub. Date: Sep. 1, 2022

(54) HARNESS FOR A DOG

(71) Applicant: INOVIKA S.R.L., Montebelluna (IT)

(72) Inventor: Giancarlo GAJO, Montebelluna (IT)

(21) Appl. No.: 17/628,605

(22) PCT Filed: Jul. 23, 2020
(86) PCT No.: PCT/IB2020/056944

§ 371 Date: Jan. 20, 2022

(30) Foreign Application Priority Data
Jul. 30, 2019 (IT) 102019000013293

(51) Int. Cl. A01K 27/00

(52) U.S. Cl. CPC A01K 27/002

(57) ABSTRACT

A harness or strapping for an animal is described, comprising a first ring that can be closed to surround in use the animal's neck, and a second ring that can be closed to surround in use the animal's chest.

The invention refers—in general—to a harness for animals, in particular a harness for walking pets such as dogs.

Particular caution is used to take dogs for a walk, because it is now established that the classic matching of collar+leash is almost certainly not good for the animal. The dog tugs of the owner's thrusts risk strangling the animal, and an inadequate collar can weaken it to the point of frustrating the workout done during the walk.

From this point of view the harnesses are much better, because they hold the dog at more points adapting better to the body. A type of harness is shown e.g., in JP3215269U.

More common harnesses are of the so-called “Norwegian” type, formed by two rings that spread apart to encircle the dog's chest and are joined behind the neck for the leash attachment. The biggest drawback is that a “Norwegian” harness compresses the dog's chest and strains the movement of the front legs at shoulder level.

Another type of common harness is the so-called “H-shaped” type, formed by two rings joined at respective diametrically opposed points by two buckles. One buckle runs along the dog's sternum, the other runs along the back. The major disadvantage is that the “H” harness is very difficult to put on the dog, and it forms a confused tangle when it is stored away.

It is therefore desired to overcome one or more of these problems with a harness according to claim 1, dependent claims defining advantageous variants. In particular, a harness or strapping for an animal is presented, comprising
a first ring closable to surround in use the animal's neck,
a second ring closable to surround in use the animal's chest,
at first, e.g. rectilinear, segment which joins two first perimeter points of said rings and which—in use—runs along the back of the animal,
a second, e.g. straight, segment which joins two second perimeter points of said rings different from the first perimeter points and—in use—runs along one side of the animal,
a third, e.g. straight, segment which joins two thirds perimeter points of said rings different from the first and second perimeter points and—in use—runs along the other side of the animal.

The configuration of the three segments that join the rings prevents the dog's chest from being compressed, and the lack of a strap passing directly over the sternum avoids entanglement after use.

Another advantage is that the shape of the harness follows the profile of the dog's body, thereby decreasing the constriction of the animal. Another advantage is that the shape of the harness prevents it from sliding on the animal if the leash pulls it sideways.

A preferred variant envisages that the second and third segments are each composed by two, e.g. rectilinear, sub-segments which form an obtuse angle, having a vertex—in use—approximately above the shoulder of the animal (at a point intermediate of the space present between the two rings). Said sub-segments with their mutual angulation determine a bight that joins the two rings surrounding the animal's shoulder, with the advantage of not compressing or forcing it.

A preferred variant envisages that from each of said vertexes a fourth, e.g. straight, segment extends joining the vertex and one of said first perimeter points, the one relating to the second ring.

A more preferred variant envisages that the fourth segment is not straight but curved, with a curvature radius directed towards the second ring.

A more preferred variant envisages that the two sub-segments are not straight but curved, with a curvature radius directed—in use—towards the animal's pawns.

A preferred variant envisages that at the first perimeter point relative to the second ring there is a connecting means to a leash, such as e.g. a buttonhole, an eyelet or a ring.

A preferred variant envisages that the first ring and/or the second ring can be closed by means of a closing means, able to attach free ends of the ring when open. E.g. the closing means is an adjustable closing means. E.g. the closing means is a sliding buckle or snapping fit or a button.

A preferred variant envisages that the closing means is connected to the respective ring by means of one or more rivets or seams.

A preferred variant envisages that the connection means to a leash is connected to the respective ring through one or more rivets or seams.

A preferred variant envisages that one or each of said segments is made of a material chosen between microfibre, leather, fabric, or plastic or rubber.

A preferred variant provides for the harness or strapping to be a single flexible body, obtained e.g. by molding or die-cutting from a sheet of material. In particular, the single body comprises said segments.

A preferred variant envisages that the harness or strapping is made entirely of plastic or rubber.

In a preferred variant, said first segment comprises an elastically extensible element or insert, made out a material different from that of the first segment, to dampen the tugs on the leash.

The elastically extensible element is e.g.

accordion-shaped or extendable zig-zag, and/or

made of rubber, and/or

placed between the perimeter of the first ring and the length of the first segment.

In a preferred variant the harness comprises a panel of insulating and/or transpiring fabric for dressing the dog, wherein the panel is connected or attachable to the first segment and/or to the first ring and/or to the second ring and/or the second segment and/or the third segment.

In a preferred variant the harness comprises a bag or container or pocket for storing objects therein, wherein the bag or container or pocket is connected or attachable to the first segment and/or the first ring and/or the second ring and/or the second segment and/or the third segment.

A method for producing a harness or strapping for an animal as defined above is also proposed, comprising

cutting or die-cutting a shaped piece from a sheet of flexible material, which folded around the body of the animal makes said first and second ring and said first, second and third segments.

A method for producing a harness or strapping for an animal as defined above is also proposed, comprising

injecting molten material into a mold to obtain a flexible shaped piece, which folded around the body of the animal makes said first and second ring and said first, second and third segment.

In particular, said shaped piece preferably has a central axis of symmetry and comprises in plan view
a central portion, to form said first segment;
a pair of end portions, wherein each pair extends cantilevered respectively from one end of the central portion in opposite directions along an axis orthogonal to the central portion, the segments of a pair being preferably substantially parallel to those of the other pair, for forming the first closable ring and the second closable ring;
two lateral segments extending spaced apart from, and on opposite sides of, the central portion and joining two intermediate points of the end portions, for forming the second and third segments.

To form said two sub-segments, said two lateral segments are composed of two segments which form an obtuse angle, with the vertex facing the central portion.

To form the fourth segment, the shaped piece comprises a fourth segment that joins the vertex and the central portion at the point from which two end portions of a pair extend. In a variant, at the joining area between the first segment and one or each of the two first perimeter points, the harness is made of elastic and/or extendable material, e.g. with bellows structure.

In a variant, at the joining area between two sub-segments of the second and/or third segment, the harness is made of elastic and/or stretchable material, e.g. with bellows structure.

The advantages of the invention will be clearer from the following description of a preferred embodiment of harness, referring to the attached drawing in which

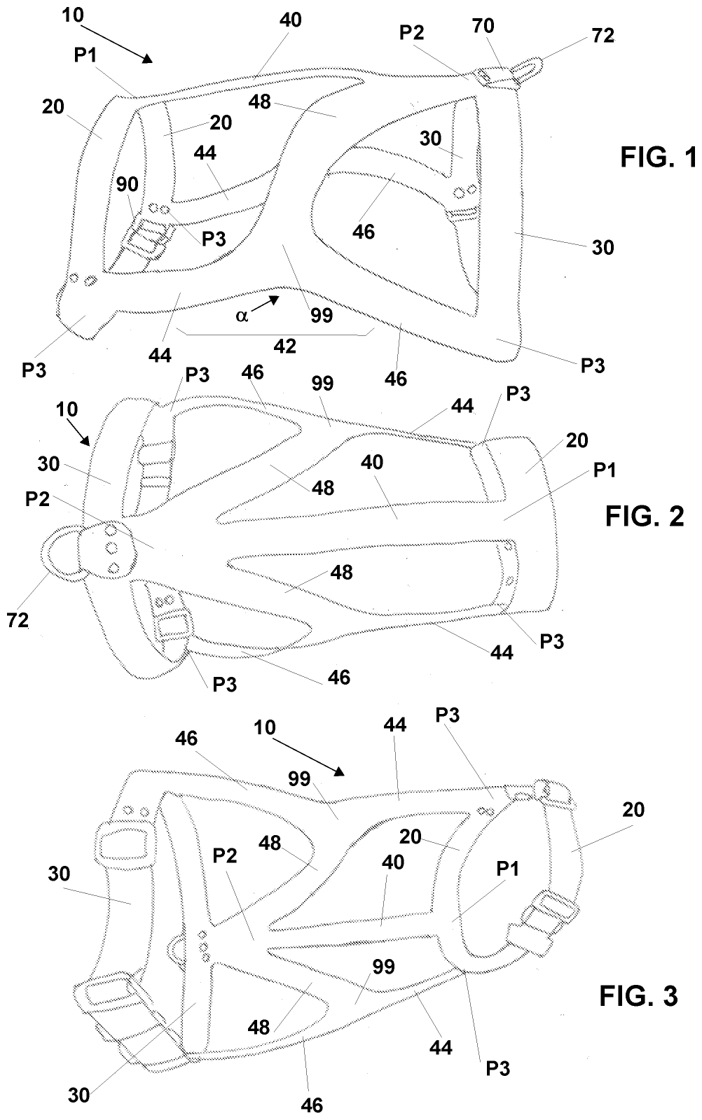

FIG. 1 shows a side view of a harness for dog,

FIG. 2 shows a top view of the harness of FIG. 1;

FIG. 3 shows a view from below of the harness of FIG. 1;

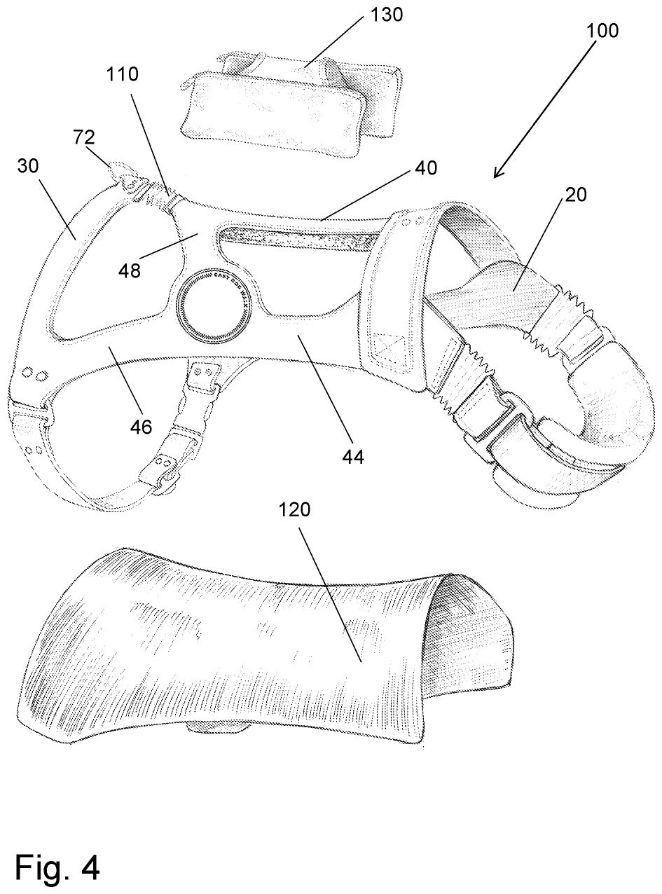

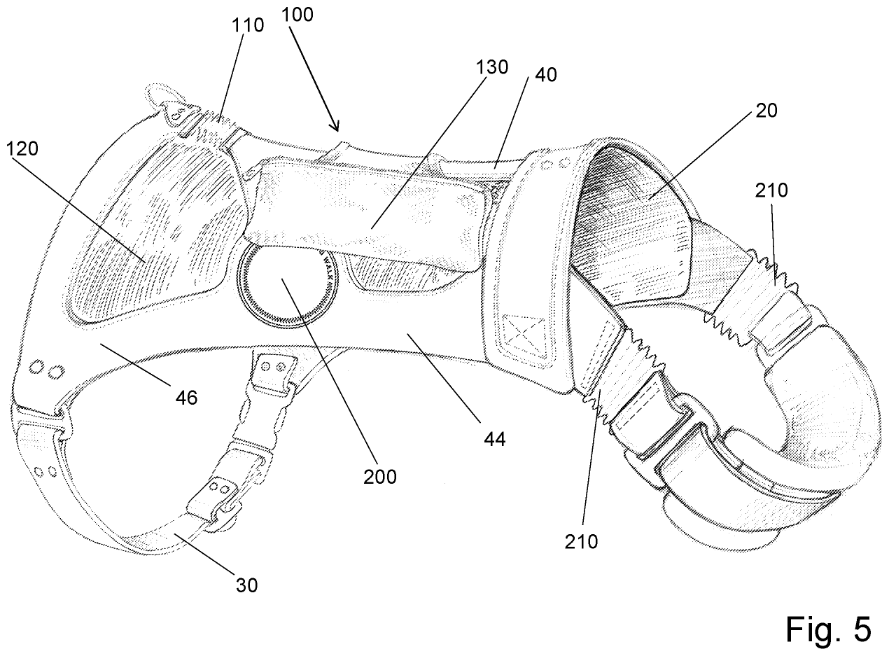

FIGS. 4 and 5 show a view of a variant of a harness for dog.

In the figures, same numbers indicate identical or conceptually similar parts.

A harness or strapping 10 for an animal comprises a first ring 20, closable for surrounding in use the animal's neck, and a second ring 30, which can be closed to surround in use the chest of the animal.

The two rings 20, 30 are connected by a first straight segment 40, which joins two perimeter points P1, P2 of the rings 20, 30 and which—in use—follows the back of the animal.

At point P2 on an eyelet 70 a ring 72 is mounted to tie the harness to a leash. The eyelet 70 can be made e.g. by fixing two flaps together with rivets or seams.

Each ring 20, 30 can be closed by a closing means, e.g. a snap fit 90 able to attach free ends of the ring when open. In this way it is easy to attach the harness to the body of the animal.

The two rings 20, 30 are connected—in use—also along the sides of the animal.

A second and third segment 42, equal to each other, join perimeter points P3 of the rings 20, 30. The points P3 are different from the points P1, P2 and when the harness 10 is applied to the animal they locate on the sides of the animal.

The second and third segments 42 are each composed of two, e.g. straights, sub-segments 44, 46 which form an obtuse angle of amplitude a, having vertex 99—in use—approximately above the animal's shoulder. The shoulder of the animal in use is located under the vertex 99, being surrounded by it but not hindered.

From each vertex 99 there extends a fourth, e.g. straight, segment 48 which joins the vertex 99 and the point P3. More preferably, the fourth segment 48 is curved, with concavity directed towards the ring 30 and/or the sub-segment 46.

As an advantageous variant, which improves the comfort for the animal, at the point P2 and/or the vertex 99 the material of the harness may have an elastic structure. In particular, at point P2 and/or vertex 99 the material of the harness has a bellows structure or an extendable structure.

FIGS. 4 and 5 show a view of a variant 100 of the harness. FIG. 5 shows the harness with mounted components.

The harness 100 shares many aspects with the variant of FIGS. 1-3, and will not be repeated.

A first difference is that the straight segment 40 connecting the two rings 20, 30 now comprises an elastically extendable member or a damping member 110, e.g. having an accordion or zig-zag structure. The member 110 attenuates the dog's tugging on the leash.

Preferably the member 110 is mounted between the perimeter of the ring 30 and the segment 40.

A second difference is that under the straight segment 40 a breathable cover or a thermal blanket 120 may be housed to give protection to the dog. The blanket 120 can be attached to the segment 40 and/or to the segment 48 and/or to the rings 20, 30, e.g. with velcro or laces or press studs.

A third difference is that a pocket or bag or container 130 may be accommodated above the straight segment 40 for storing objects. The pocket or bag 130 can be attached to the segment 40 and/or to the segment 48 and/or to the rings 20, 30, e.g. with velcro or laces or press studs.

The elements indicated in the previous three differences can be implemented alone or in combination on a harness.

Other variants that can be implemented in each variant described are the following:

preferably the harness comprises a pocket 200 on the outer surface of the segment 44 and/or segment 48. The pocket 200 may also carry a logo or writing;

preferably one or each of the rings 20, 30 comprise an elastic segment 210, for dampening the tension and making the perimeter of the ring slightly extendable. The elastic segment 210 has e.g. bellows structure.

1. Harness or strapping for an animal, comprising:
a first ring that can be closed to surround in use the animal's neck,
a second ring that can be closed to surround in use the animal's chest,
a first segment which joins two first perimeter points of said rings and which—in use—runs along the animal's back,
a second segment which joins two second perimeter points of said rings different from the first perimeter points and—in use—runs along one side of the animal,
a third segment joining two third perimeter points of said rings different from the first and second perimeter points and—in use—runs along the other side of the animal.

2. Harness or strapping according to claim 1, wherein the second and third segments are each composed of two sub-segments which form an obtuse angle, having vertex—in use—about above the shoulder of the animal.

3. Harness or strapping according to claim 2, wherein from each of said vertex there extends a fourth segment which joins the vertex and one of said first perimeter points, that relating to the second ring.

4. Harness or strapping according to claim 3, wherein the fourth segment is curved, with a radius of curvature directed towards the second ring.

5. Harness or strapping according to claim 2, wherein the two sub-segments are curved, with a radius of curvature directed—in use—towards the animal's pawns.

6. Harness or strapping according to claim 1, comprising a connecting means to a leash at the first perimeter point relative to the second ring.

7. Harness or strapping according to claim 1, comprising a closing means for closing the first ring and/or the second ring by attaching free ends of the ring.

8. Harness or strapping, according to claim 1, wherein one or each of said segments is made of a material selected from microfibre, leather, fabric, or plastic or rubber.

9. Method for producing a strapping or harness for an animal as defined in claim 8, comprising the step of
cutting or die-cutting from a sheet of flexible material a shaped piece, which when folded around the body of the animal makes said first and second rings and said first, second and third segments.

10. Method for producing a strapping or harness for an animal as defined in claim 9, comprising the step of injecting molten material into a mold to obtain a flexible shaped piece, which when folded around the body of the animal forms said first and second ring and said first, second and third segments.

11. Harness or strapping according to claim 3, wherein the two sub-segments are curved, with a radius of curvature directed—in use—towards the animal's pawns.

12. Harness or strapping according to claim 4, wherein the two sub-segments are curved, with a radius of curvature directed—in use—towards the animal's pawns.
